(19) United States
(12) Patent Application Publication
(10) Pub. No.: US 2009/0040257 A1
(43) Pub. Date: Feb. 12, 2009

(54) INKJET PRINTHEADS WITH WARMING CIRCUITS

(76) Inventors: Steven Wayne Bergstedt, Winchester, KY (US); Prabuddha Jyotindra Mehta, Lexington, KY (US); George Keith Parish, Winchester, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/834,177

(22) Filed: Aug. 6, 2007

(51) Int. Cl. B41J 29/38

(52) U.S. Cl. 347/17; 347/9

(57) ABSTRACT

A thermal inkjet apparatus includes a printhead body, nozzles, ink cavities and ink supply lines. Heater resistors are in the cavities and a firing circuit is connected to provide firing pulses to the heater resistor and nucleate the ink so that it fires ink out of the nozzles. Each heater resistor is also connected to a warming circuit that supplies warming pulses, one warming pulse during each firing cycle, to warm the heater resistors but not nucleate the ink. The warming circuit includes current limiting ballast resistors to limit the current through the healer resistors and thereby prevent the warming pulse from nucleating the ink. Warming pulses and firing pulses are not generated during the same firing cycle for a particular heater resistor. One or more thermal sensors are disposed on the printhead body to sense the temperature and a control circuit responds to the sensors to generate warming pulses having desired widths to provide a desired level of warming. By wide range pulse width modulation of the warming pulse, the warming effect of the warming pulse may be increased or decreased as desired. Also the warming pulse may be completely eliminated, such as by pulse width modulating the pulse to have a zero duration.

### BACKGROUND OF THE INVENTION

The present invention relates to the field of thermal inkjet printhead warming and particularly relates to a technique for warming the printhead without creating interference in the operation of the printhead.

### BACKGROUND AND SUMMARY OF INVENTION

In thermal inkjet printers, print quality and jetting reliability are dependent on the temperature of the inkjet integrated circuit, the printhead. In a thermal inkjet printhead, inkjets are ejected by boiling a single bubble at intense heat for a very short duration. This process is repeated thousands of times per second for each nozzle, on the printhead resulting in an accumulation of heat that raises the temperature of the ink. Variations in ink temperature affect the shape, size and velocity of ejected drops resulting in variations of density that may be perceivable to the eye. To alleviate this problem, various printhead thermal control systems have been developed. However, these prior art thermal control systems have often created artifacts or electromagnetic noise that interferes with the operation of the printhead. Some prior art uses very narrow non-nucleating heating pulses in the heater resistors. The range of control is limited by longer pulse widths near the onset of nucleation and narrow pulse widths that are limited by the pulse generator clock resolution. A typical non-nucleating heating pulse control range might be from 70 to 250 nanoseconds. Thus, the thermal control systems that were designed to create additional reliability sometimes create problems.

In accordance with the present invention a thermal control system for a printhead is disclosed that avoids interference with the operation of the printhead. In one embodiment, a thermal inkjet apparatus is disclosed that includes a printhead body with nozzles formed in the body. Ink cavities are formed in the body that contain ink that is communicated to the nozzles to supply ink to a media, such as paper. The ink is supplied to the ink cavities by ink supply lines and heater resistors are disposed in the cavities. A firing circuit is connected to the heater resistor and it supplies a firing pulse to the heater resistors causing the heater resistors to heat sufficiently to nucleate the ink in the cavities and fire the ink out of the nozzles. In addition, a warming circuit is connected to the heater resistors and it supplies warming pulses to the heater resistors. The warming pulses heat the heater resistors sufficiently to warm the printhead but insufficiently to nucleate the ink. Thus, the warming pulses warm the printhead but do not fire ink out of the nozzles.

In a particular embodiment, the warming circuit includes a current limiting ballast resistor with at least one such current limiting ballast resistor (which may be constructed in polysilicon) connected in series with each of the heater resistors. These current limiting ballast resistors limit the flow of current through the heater resistors to a desired level. Warming switches are connected to supply warming pulses to the ballast resistors and heater resistors to heat the ballast resistors and heater resistors and thereby heat the printhead body but not nucleate the ink. Similarly the firing circuit includes a firing switch with at least one firing switch connected to each heater resistor for supplying firing pulses to the heater resistors. The current limiting ballast resistors may be located in the cavity with the heater resistors, or the ballast resistors may be located outside the cavities or in both places. In such case, two ballast resistors would be used, one inside the cavity and one outside the cavity.

In a particular embodiment, to achieve the desired warming characteristics, at least one thermal sensor is disposed to sense the temperature of the printhead body and produces a sensor signal indicating such temperature. A control circuit is connected to the thermal sensor and determines a value corresponding to the temperature of the body based on the sensor signal. The control circuit then generates control signals based on the value and transmits them to a pulse control circuit. The pulse control circuit performs multiple functions but one of its functions is to supply warming pulses to the warming circuit in response to the control signals. The pulse control circuit preferably varies the width of the warming pulse to achieve the desired warming effect. In other words, a longer warming pulse is produced if more warming effect is desired. Thus, the pulse control circuit produces control signals designating the width of a desired warming pulse based on the temperature of the body.

In one embodiment, the warming circuit includes a relatively smaller field effect transistor operating as a switch to switch the warming pulses on and off and the firing circuit includes a relatively larger field effect transistor connected to switch the firing pulses on and off. The smaller warming field effect transistor has a lesser current carrying capacity than the firing field effect transistor. The smaller warming field effect transistor is required to carry a lesser current and therefore is smaller to save space in the overall construction of the warming circuit.

When a particular heater has been fired rapidly during the preceding time periods, the ink will be relatively warm in that cavity and that portion of that printhead will likewise be relatively warm. Thus, assuming the temperature feedback system discussed above indicates that little warming is required, the pulse control system will designate a relatively small width for the warming pulse so that very little warming is produced. Also, the pulse control system monitors the firing of the heater resistors as well. If a particular heater resistor is firing during a print cycle, the control system will not initiate the creation of a warming pulse. In other words, the pulse control system will not produce a warming pulse and a firing pulse at the same time.

Considering the above discussion, it will be appreciated that a method is taught for warming a thermal inkjet printhead that has a heater resistor responding to firing pulses during firing cycles to nucleate ink and fire the ink from a nozzle. The method includes supplying a warming pulse to the heater resistor to warm the heater resistor and to thereby warm the printhead and further includes pulse width modulating the warming pulse to produce a pulse having a width that is sufficient to warm the heater as desired but insufficient to nucleate the ink. In this method, only one pulse width modulating warming pulse is produced during one firing cycle for one heater resistor. Further, a warming pulse is not supplied to a heater resistor that is receiving a firing pulse during a particular firing cycle.

In one embodiment of this method, the temperature of the printhead is monitored and warming pulses are supplied only as needed to raise the temperature of the printhead to a desired temperature. In this respect, the warming pulses may be modulated to have a width that will create the desired warming effect, or the warming pulses may be omitted entirely if the printhead is sufficiently warm. In this method, the current is intentionally limited in the warming pulse to a current level that is lower than the firing pulse so that the warming pulse will not nucleate the ink.

### BRIEF DESCRIPTION OF THE DRAWINGS

An exemplary embodiment is disclosed in the detailed description and the figures in which:

FIG. 1 is a somewhat diagrammatic drawing of a printhead with a thermal control system and pulse control system within a control circuit;

FIG. 2 is a somewhat diagrammatic drawing of an exemplary ink cavity and nozzle system showing a heater resistor with a firing circuit and a warming circuit connected to the heater resistor;

FIG. 3 is a circuit diagram illustrating the warming circuit and the firing circuit that is connected to the heater resistor; and

FIG. 4 is a waveform showing a pulse width modulated warming pulse used to perform the heater resistor.

### DESCRIPTION OF THE DRAWINGS

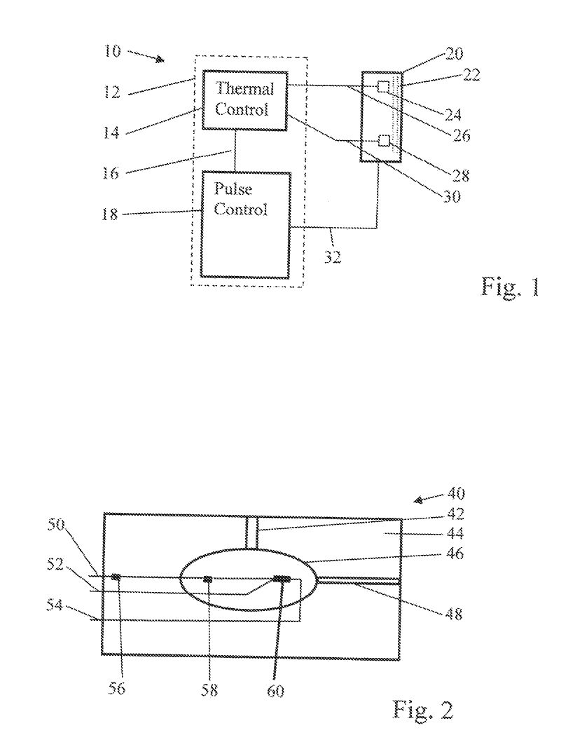

Referring now to the drawings in which like reference characters designate like or corresponding parts throughout the several views, there is shown in FIG. 1 a printhead apparatus 10 including a control circuit 12 that is connected to a printhead 20. The control circuit 12 includes a thermal control circuit 14 and a pulse control circuit 18 connected by line 16. It will be understood that the circuits 12, 14 and 18 may be implemented in software and do not necessarily represent separate physical units.

The inkjet printhead 20 includes a plurality of nozzles 22 for ejecting ink out of the printhead and onto a print media. Thermal sensors 24 and 28 are mounted on the printhead 20 to sense the temperature of the printhead and sensor lines 26 and 30 connect the sensors 24 and 28 back to the thermal control circuit 14. The lines 26 and 30 may be regarded as part of the thermal control circuit 14. In operation, the temperature sensors 24 and 28 generate sensor signals that are applied back to the thermal control circuit 14 that in turn supplies control signals to the pulse control circuit 14 that are based on the temperature of the printhead 20. The thermal control circuit 14 and the pulse control circuit 18 produce a pulse width modulated signal that is applied through line 32 to the printhead and causes the printhead to produce warming pulses that warm the printhead. If the printhead is below a desired temperature, the thermal control circuit 14 will produce warming pulses having greater widths or durations so that the warming pulses have a greater warming effect on the printhead. On the other hand, if the printhead is very near the correct operating temperature, but is slightly cooler then it should be, the thermal control circuit 14 and the pulse control circuit 18 will produce warming pulses having durations (a width) that are much smaller and will have a small warming effect. The printhead 20 is rapidly firing the nozzles 22 one time per firing cycle. During a firing cycle, the pulse control circuit 18 will either produce a firing pulse to nucleate ink and eject it from a particular nozzle or the circuit 18 will produce a warming pulse to warm the printhead 20 in the vicinity of a particular nozzle that is not being fired during the firing cycle, or the circuit will produce no pulses and nothing happens.

The operation and effect of the warming pulse and the firing pulse for each nozzle may best be understood by reference to FIG. 2 which schematically illustrates part of the construction of the warming circuit (line 50) and the firing circuit (line 52) in the vicinity of a nozzle 48. Each of the nozzles 22 of FIG. 1 and the related structures and circuits are constructed as represented in FIG. 2. The nozzle assembly 40 shown in FIG. 2 includes an ink supply line or via 42 that supplies ink to an ink cavity 46. A nozzle 48 extends from the ink cavity 46 to the outer surface of the nozzle assembly 40. The ink that is supplied by the via 42 is nucleated in the cavity 46 and ejected from the nozzle 48 during printing operations. A heater resistor 60 is provided inside the cavity 46 for heating the ink within the cavity. The heater resistor 60 is connected through line 54 to a power supply and switch discussed herein and is connected to a ground through line 52 or line 50. Line 52 represents part of a firing circuit and line 50 represents part of a warming circuit. When it is desired to nucleate the ink within the cavity 46, a firing pulse causes power to flow through the resistor 60 from line 54 and through line 52. This power is sufficient to nucleate the ink and eject it from the nozzle 48. When it is desired to warm the ink within the cavity 46 but not nucleate it, the line 50 is switched on and current flows through line 54, through the heater resistor 60 and through two ballast resistors 56 and 58. The ballast resistors 56 and 58 are current limiting resistors and limit the amount of current that flows through the heater resistor 60, thereby limiting the current to a desired level that does not overheat the ink within the cavity 46 and does not nucleate the ink. In this particular illustration, a ballast resistor 56 is shown outside of the cavity 46 and another ballast resistor 58 is connected inside the cavity 46. This embodiment illustrates that the ballast resistors may be positioned in different places and there may be one, two or more resistors. In other embodiments, only resistor 56 or only resistor 58 may be supplied, or, alternatively, more ballast resistors may be supplied. A function of the ballast resistors, again, is to provide heating while limiting the flow of current through the heater resistor 60 and this may be accomplished by one or more resistors having the combined desired current limiting effect.

Referring now to FIG. 3, a more detailed view is shown of the warming circuit and the firing circuit used in connection with each heater resistor 60 for each of the nozzles 22. In this circuit diagram, a power supply 70 is connected to one end of a heater resistor (R_{HTR}) 72 and the other end of heater resistor 72 is connected by line 74 to a junction 76. The junction 76 is connected to both a warming circuit through line 78 and a firing circuit through line 82. Referring first to the warming circuit, the line 78 is connected to a ballast resistor (R_{X}) 80, which may be constructed in polysilicon and is connected through line 84 to a warming field effect transistor (R_{FET}) 86. The transistor 86 functions as a switch that turns the warming circuit on and off in response to a control signal that is supplied through line 88. The opposite side of the field effect transistor 86 is connected to ground 90. When a control signal is supplied to line 88, the transistor 86 turns on and completes the circuit from the power supply 70 through the heater resistor 72, through the ballast resistor 80, and through the transistor 86 to ground 90. As will be described in greater detail hereinafter, the control signal on line 88 is a pulse width modulated signal that has a width of a particular duration and while that signal is present, the current will continue to flow through the heater resistor 72 and the ballast resistor 80, both of which wall warm the printhead but will not nucleate the ink.

Referring to FIGS. 2 and 3, the heater resistor 72 corresponds to the heater resistor 60 shown in FIG. 2. The ballast resistor 80 in FIG. 3 represents one or both of the resistors 56 and 58 shown in FIG. 2. Thus, resistor 80 may represent multiple resistors connected in series or connected in parallel depending on a particular desired design. The ultimate effect of the ballast resistor 80, however, must be to limit the current that flows through the heater resistor 72 so that the ink is warmed but not nucleated by a warming pulse controlled by the transistor 86.

Referring again to junction 76, it is also connected to line 82 which is connected to ground 90′ through a firing field effect transistor (R_{PP}) 92. The firing pulse is applied to transistor 92 through line 94. Line 94 is connected to an and gate 96 that represents an addressing system. When all three signals (PFIRE, A, EA) on lines 98, 100 and 102 are “on”, the and gate will cause an “on” signal to be applied to line 94 which will turn on the field effect transistor 92 (a switch) and a firing pulse will flow from power 70 through heater resistor 72 and through transistor 92 to ground 90. The and gate 96 is illustrated with three control lines or address lines attached to it. It will be understood that various different types of control and address systems may be used and that the current embodiment shows three control lines only as an illustration and there is no intent to limit this particular embodiment to any particular number of address lines or control lines. As previously mentioned, a warming pulse and a firing pulse are not generated at the same time. Thus, line 88 will not turn on at the same time as line 94. The circuit shown in FIG. 3 would allow such action to occur, but the control circuit 12 is programmed to not allow the signals on line 88 and 94 to both turn on at the same time.

Depending on the particular design, turning “on” a line, such as lines 88 or line 94, would require the voltage on the line to go from a lower state to a higher state or from a higher state to a lower state depending on the design. By referring to “on” conditions and “off” conditions, it is intended to generalize the condition of FIG. 3 to cover both types of circuits.

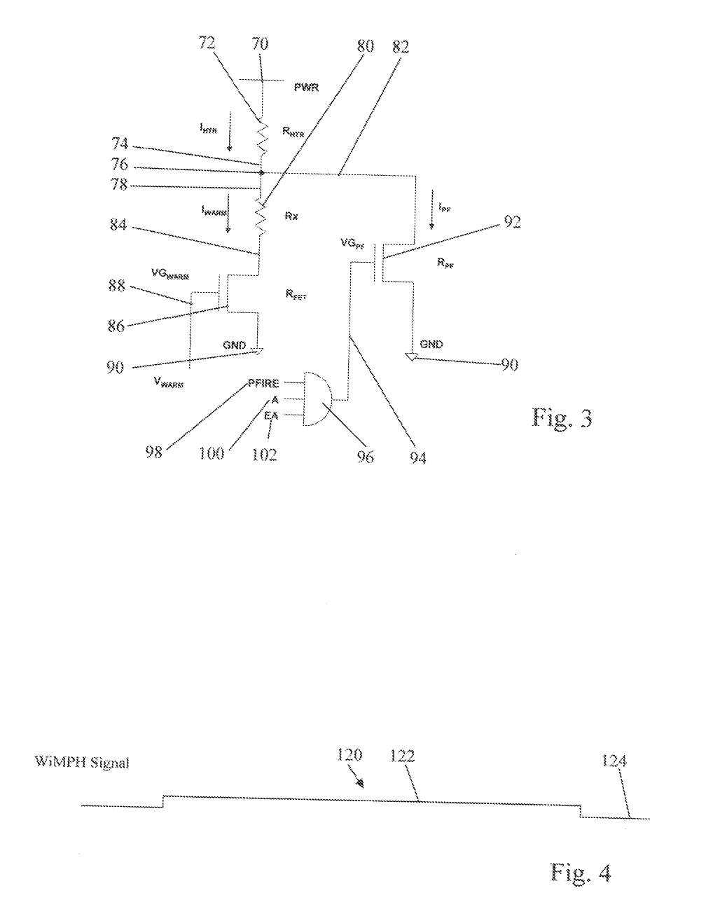

Referring now to FIG. 4, a representative pulse width modulated signal is shown. This signal may be referred to by the acronym WiMPH which stands for width modulation for primitive heating. In FIG. 4, a pulse 120 is shown having a pulse width indicated by the reference number 122 and a low state 124. The pulse width 122 increases when more heat is required and decreases when less heat is required. The control system produces only one pulse 122 during a particular firing cycle. But, if desired, additional pulses could be provided, for example, instead of having one pulse, it may be preferred to have two or three pulses. However, the number of pulses is intentionally maintained at a low number, such as one, to reduce possible interference with other operation of the printhead.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A thermal inkjet apparatus comprising:
a printhead body,
nozzles formed in the body,
ink cavities formed in the body for containing ink and communicating ink to each nozzle,
ink supply lines for supplying ink to the cavities,
heater resistors disposed in the cavities,
a firing circuit connected to the heater resistors for supplying firing pulses to the heater resistors for heating the heater resistors sufficiently to nucleate the ink in the cavities and fire the ink out of the nozzles, and
a warming circuit connected to the heater resistors for supplying warming pulses to the heater resisters for heating the heater resistors insufficiently to nucleate the ink and for warming the ink in the cavities but not nucleating the ink and not firing ink out of the nozzles.

2. The apparatus of claim 1 wherein the warming circuit comprises:
current limiting ballast resistors with at least one current limiting ballast resistor connected in series with each of the heater resistors for limiting the flow of current through the heater resistor to a desired level, and
warming switches connected to supply warming pulses to the ballast resistors and heater resistors to heat the ballast resistors and the heater resistors and thereby heat the body but not nucleate the ink.

3. The apparatus of claim 2 wherein the ballast resistors are fabricated in polysilicon.

4. The apparatus of claim 2 wherein the firing circuit comprises firing switches with at least one firing switch connected to each heater resistor for supplying firing pulses to the heater resistors.

5. The apparatus of claim 1 wherein the warming circuit comprises:
current limiting ballast resistors with at least one current limiting ballast resistor located in each cavity connected in series with each of the heater resistors for limiting the flow of current through the heater resistor to a desired level, and
warming switches connected to supply warming pulses to the ballast resistors and heater resistors to heat the ballast resistors and the heater resistors and thereby heat the body but not nucleate the ink.

6. The apparatus of claim 1 wherein the warming circuit comprises:
current limiting ballast resistors located in the body and outside of the cavities with at least one current limiting ballast resistor connected in series with each of the heater resistors for limiting the flow of current through the heater resistor to a desired level, and
warming switches connected to supply warming pulses to the ballast resistors and heater resistors to heat the ballast resistors and the heater resistors and thereby heat the body but not nucleate the ink.

7. The apparatus of claim 1 further comprising:
at least one thermal sensor disposed to sense the temperature of the body and for producing a sensor signal indicating the temperature of the body;
a thermal control circuit connected to the thermal sensor for determining a value corresponding to the temperature of the body based on the sensor signal and for generating control signals based on the value, and
a pulse control circuit for supplying warming pulses to the warming circuit in response to the control signals to warm the body, the control circuit supplying control signals to warm the body to a desired temperature.

8. The apparatus of claim 6 wherein the control circuit produces control signals designating the width of a desired warming pulse based on the temperature of the body and wherein the pulse control circuit produces a warming pulse having the width designated by the control signal.

9. The apparatus of claim 1 further comprising a control circuit for supplying warming pulses and for pulse width modulating the warming pulses to change the heating effect of the warming pulses.

10. The apparatus of claim 1 wherein the warming circuit comprises a warming field effect transistor connected to switch on and off and thereby supply the warming pulses and wherein the firing circuit further comprises a firing field effect transistor connected to switch on and off and thereby provide the firing pulses.

11. The apparatus of claim 10 wherein the warming field effect transistor is smaller than the firing field effect transistor and has a lesser current carrying capacity than the firing field effect transistor.

12. The apparatus of claim 1 further comprising a control circuit for controlling when the firing pulses and when warming pulses are produced such that a warming pulse is not produced during a firing pulse.

13. In an inkjet printhead having heater resistors disposed in ink for receiving firing pulses and heating the ink to a nucleating temperature in response to firing pulses being applied by firing circuits to the heater resistors, a warming apparatus comprising:
warming circuits connected to supply warming pulses to the heater resistors sufficient to warm the heater resistors but insufficient to nucleate the ink to thereby warm the printhead, the warming circuits being at least partially separate from the firing circuits and providing a separate electrical path through the heater resistor.

14. The warming apparatus of claim 13 further comprising a control circuit for supplying the warming pulses and for pulse width modulating the warming pulses to change the heating effect of the warming pulses.

15. The warming apparatus of claim 13 further comprising:
at least one thermal sensor disposed to sense the temperature of the printhead and for producing a sensor signal indicating the temperature of the printhead;
a thermal control circuit connected to the thermal sensor for determining a value corresponding to the temperature of the printhead based on the sensor signal and for generating control signals based on the temperature of the printhead, and
a pulse control circuit for supplying warming pulses to the warming circuit in response to the control signals to warm the printhead, the control circuit supplying control signals to warm the printhead to a desired temperature.

16. The warming apparatus of claim 14 wherein the control circuit produces control signals designating the width of a desired warming pulse based on the temperature of the body and wherein the pulse control circuit produces a warming pulse having the width designated by the thermal control circuit.

17. A method of warming a thermal inkjet printhead having a heater resistor that responds to firing pulses during firing cycles to nucleate ink and fire the ink from a nozzle, comprising:
supplying a warming pulse to the heater resistor to warm the heater resistor and thereby warm the printhead, and
pulse width modulating the warming pulse to produce a pulse having a width that is sufficient to warm the heater resistor and is insufficient to nucleate the ink.

18. The method of claim 17 further comprising supplying a warming pulse to each particular the heater resistor only during firing cycles in which the particular heater resistor is not receiving a firing pulse.

19. The method of claim 17 further comprising:
monitoring the temperature of the printhead, and
supplying warming pulses only as needed to raise the temperature of the printhead to a desired temperature.

20. The method of claim 17 further comprising limiting the current in the warming pulse to a current level that is lower than the current of the firing pulse so that the warming pulse will not nucleate the ink.
